(19) United States
(12) Patent Application Publication
(10) Pub. No.: US 2011/0029352 A1
(43) Pub. Date: Feb. 3, 2011

(54) BROKERING SYSTEM FOR LOCATION-BASED TASKS

(75) Inventors: James Kai Yu Lau, Bellevue, WA (US); Katrika Woodcock, Issaquah, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/533,851

(22) Filed: Jul. 31, 2009

(51) Int. Cl. G06Q 30/00; G06Q 10/00; G06Q 50/00

(52) U.S. Cl. 705/9; 705/14.51; 705/26.25

(57) ABSTRACT

Brokering locations for the completion of tasks. Location information for a plurality of sellers is maintained. Buyers define tasks to be performed at particular task locations at particular times. A brokering system notifies the sellers of the defined tasks, and selects sellers near the task locations to complete the tasks. The sellers complete the tasks to produce output such as a physical or digital deliverable. Upon verifying completion of the task, the brokering system arranges the transfer of compensation between the buyers and the sellers. In some embodiments, the brokering system selects the sellers via an auction to enable the performance of various buyer-defined tasks that are location-specific. Further, location-based applications may be built on top of the brokering system.

### BACKGROUND

Online marketplaces have emerged as a means to connect buyers and sellers. Internet web sites, intranet bulletin boards, and other such marketplaces enable sellers to offer products for sale while inviting buyers to browse and purchase the products. Purchased products are delivered to the buyers physically (e.g., shipped) or electronically (e.g., downloaded) depending on the type of purchased product. Because of the available delivery options, with existing systems, the location of the seller or the products is largely irrelevant, and often unknown, to the buyer. Accordingly, the existing systems are product-focused. For example, most web site retailers organize the products for sale by the category or type of the products, rather than the locations of the products. While some existing systems may organize some of the products based on country of origin, such existing systems are narrowly tailored to the particular products being offered. Further, the buyers are limited to selecting from the products made available for sale by the sellers.

### SUMMARY

Embodiments of the disclosure broker locations for task performance. Location information is maintained for a plurality of sellers. The location information identifies locations corresponding to the plurality of sellers. Tasks to be performed by the sellers are stored in a memory area. The tasks are received from one or more buyers. The stored tasks are assigned to one or more of the sellers based at least on the location information. The sellers perform the assigned tasks to produce output. The performance of the assigned tasks by the sellers at the locations corresponding thereto is verified. Responsive to the verification, the produced output is provided to the buyers.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a plurality of buyers communicating with a plurality of sellers via a location-based brokering system.

FIG. 2 is an exemplary block diagram illustrating selection of one of the sellers to complete a task and compensation for task completion.

FIG. 3 is an exemplary block diagram illustrating a computing device having a memory area storing components for implementing the location-based brokering system.

FIG. 4 is an exemplary flow chart illustrating selection of the sellers and compensation to the selected sellers for performing tasks.

Corresponding reference characters indicate corresponding parts throughout the drawings.

### DETAILED DESCRIPTION

Referring to the figures, embodiments of the disclosure enable, at least, the brokering of locations for performing tasks 310 or jobs. In some embodiments, a real-time location brokering system 106 maintains locations of sellers 104. Location-specific tasks 310 received by the brokering system 106 are provided to the sellers 104 based on the locations of the sellers 104. The location-specific tasks 310 are defined by one or more buyers 102. The brokering system 106 verifies performance of the tasks 310, and arranges the transfer of compensation (e.g., monetary or non-monetary) between the buyers 102 and sellers 104.

In some embodiments, the brokering system 106 is hidden from the end user via one or more application programs built on top of the brokering system 106. For example, users 202 interact with the application program, which interacts with the brokering system 106 to manage performance of the desired tasks 310. For example, such an application program enables the users 202 to receive a live video feed from anywhere in the world. The application program presents a map user interface to the user 202. The user 202 requests a live video feed from anywhere by specifying a location on the map user interface. The application program uses the underlying location-based brokering system 106 to request sellers 104 in that location (or vicinity) to capture a live video feed. The captured live video feed is returned to the user 202 through the application program. In some embodiments, the entire brokering process is completely hidden from the user 202.

Embodiments of the disclosure enable buyers 102 to have tasks 310 performed by sellers 104 in particular locations. For example, the brokering system 106 enables video or image capture at a particular physical location, the identification of a ride-sharing partner at a particular physical location, obtaining an autograph from a celebrity at a concert, the purchase of event tickets from a ticket vendor at a particular physical location, and more. Furthermore, embodiments of the disclosure enable location-based applications to be built on top of the location-based brokering system 106.

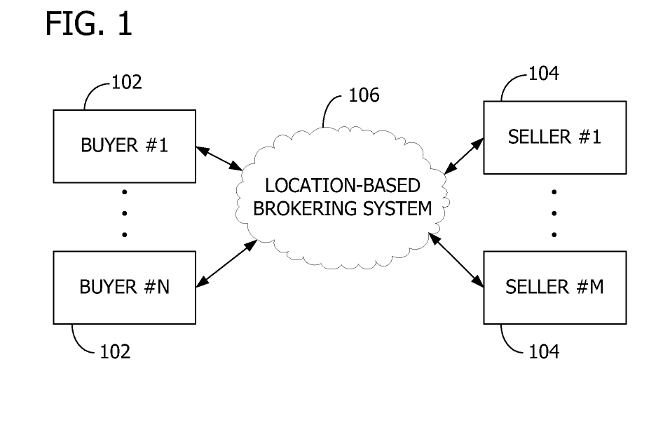

Referring again to FIG. 1, an exemplary block diagram illustrates a plurality of buyers 102 communicating with a plurality of sellers 104 via the location-based brokering system 106. The plurality of buyers 102 such as buyer #1 through buyer #N represents seekers of products and/or services. The buyers 102 may be individuals, agencies, companies, application programs, computing devices, or any other entity attempting to obtain the products and/or services. The plurality of sellers 104 such as seller #1 through seller #M represents providers of the products and/or services. The sellers 104 may be individuals, agencies, companies, application programs, computing devices, or any other entity offering to provide the products and/or services. In some embodiments, the sellers 104 are not formally affiliated. That is, aside from offering their services to the brokering system 106, the sellers 104 do not otherwise have an apparent common connection to each other.

In some embodiments, the buyers 102 and sellers 104 communicate with the location-based brokering system 106 via one or more networks (not shown). For example, the network includes any wired or wireless network including, but not limited to, the Internet, cellular networks, and BLUETOOTH brand wireless networks.

The location-based brokering system 106 is implemented by one or more computing devices arranged to provide the functionality described herein. For example, the brokering system 106 may be implemented by multiple server machines. In some embodiments, the location-based brokering system 106 is implemented as a cloud service.

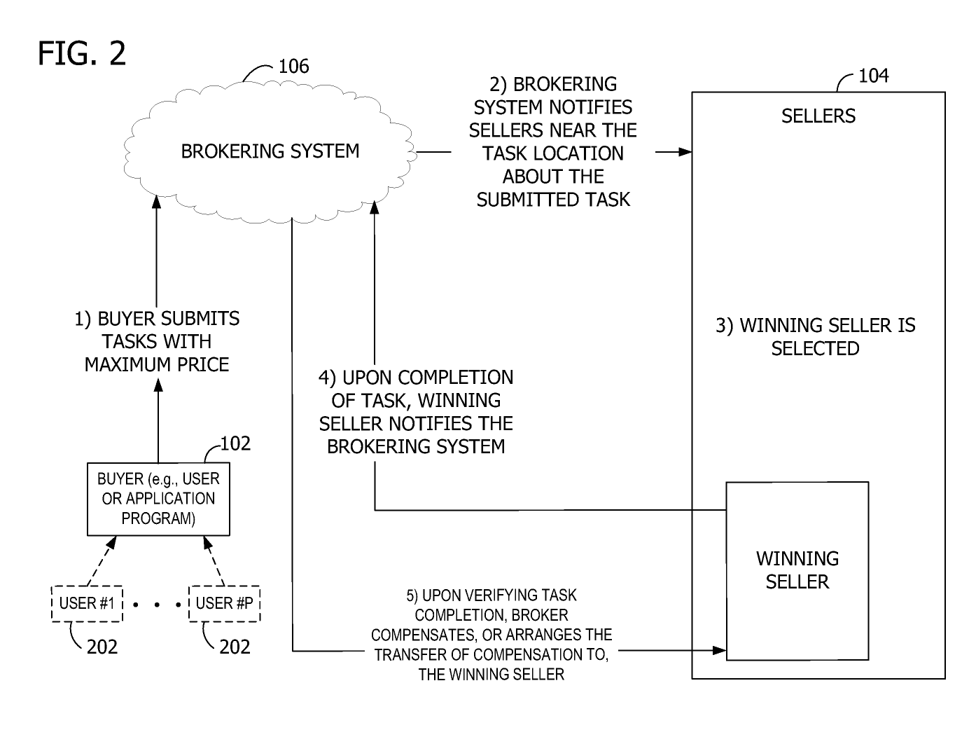

Referring next to FIG. 2, an exemplary block diagram illustrates selection of one of the sellers 104 to complete one of the tasks 310 and compensation for completion of the selected task 310. In the example of FIG. 2, the buyer 102 represents an application program communicating with the brokering system 106. One or more users 202 such as user #1 through user #P communicate with the buyer 102 (e.g., application program) to obtain products and/or services. In the example of FIG. 2, the users 202 are unaware of the interaction among the buyer 102, the brokering system 106, and the sellers 104. Further, the users 202 define the tasks 310, and communicate those to the brokering system 106 via the buyer 102 (e.g., application program). The application program may be any program that provides the products and/or services. For example, the application program may offer streaming video data from a plurality of locations as requested by the users 202.

In FIG. 2, the users 202 interact with the buyer 102 (e.g., application program) via a user interface. The user interface is displayed to the users 202 on computing devices associated with the users 202. Embodiments of the invention are operable with any computing device associated with the users 202. For example, aspects of the invention are operable with computing devices such as mobile computing devices, digital cameras, digital video cameras, netbooks, laptop computers, gaming consoles (including handheld gaming consoles), portable music players, a personal digital assistant, an information appliance, and a personal communicator. The application program executes on the same or other computing device to provide the user interface. For example, the application program executes as a web service communicating with the computing devices of the users 202.

The buyer 102 (e.g., application program) receives at least one task 310 from at least one of the users 202. The task 310 may be a free-form task defined by the user 202, or may be one of a plurality of pre-defined tasks the brokering system 106 is capable of handling. The brokering system 106 may be programmed with the pre-defined tasks, or may create and update the pre-defined tasks based on previous task requests. The received task 310 is associated with a particular location. In some embodiments, the particular location represents the location at which the task 310 is to be performed. In the example of FIG. 2, the task 310 also includes a maximum price specified by the user 202. The brokering system 106 identifies one or more sellers 104 that are near, or will be near, the location associated with the task 310 based on location information 308 maintained by the brokering system 106 or other component. The brokering system 106 notifies the identified sellers 104 about the received task 310. Alternatively or in addition, the brokering system 106 notifies each of the sellers 104 of the task 310 and allows the sellers 104 to opt in for a chance to be selected to complete the task 310.

In some embodiments, the brokering system 106 filters the tasks 310 or identified sellers 104 to refine the eligible sellers 104. For example, the task 310 may identify one of a plurality of pre-defined task categories, and the sellers 104 may specify which task categories are of interest. Example categories include video services, photo services, audio services, ride sharing, event advertising, searching for lost items, etc. The brokering system 106 filters the identified sellers 104 based on the identified task category to refine the set of eligible sellers 104. The sellers 104 may specify which task categories are of interest by, for example, advertising their availability or services to the brokering system 106. For example, one of the sellers 104 advertises availability for a task in Seattle on weekdays, or advertises a future location or event attendance (e.g., the seller 104 will be in the front row at an upcoming rock concert). In these examples, the transactions begin with the seller 104 rather than the buyer 102.

The brokering system 106 selects at least one of the sellers 104 from the identified or otherwise eligible sellers 104. Depending on the task 310, a plurality of the sellers 104 may be selected to complete the task 310. If none of the sellers 104 meets the criteria of the buyer 102 for completing the task 310, the task 310 is queued by the system 106 until a suitable seller 104 is available. In some embodiments, the selected seller 104 is referred to as the “winning seller.” Various means for selecting the winning seller are contemplated. For example, the brokering system 106 may include an auction system, a lottery system, a randomized selection system, a preferred selection system, or any other method for selecting the winning seller. In the example of FIG. 2, the brokering system 106 uses the maximum price or another consideration associated with the task request when selecting the winning seller.

The winning seller completes at least a portion of the task 310 and notifies the brokering system 106 of the completion. For example, the winning seller may notify the brokering system 106 of task acceptance, task initiation, and/or task completion. In some embodiments, the task 310 has multiple portions that may be performed concurrently or in sequence. In such embodiments, the brokering system 106 selects multiple winning sellers who each complete the respective portions and notify the brokering system 106.

The brokering system 106 receives the notification from the winning seller and verifies task completion or progression (e.g., depending on the notification received). For example, the verification performed by the brokering system 106 may include confirming that the task 310 has been fully completed, partially completed, or merely initiated. Additionally, the verification may include confirming that the winning seller is located at the location associated with the task 310 (e.g., using global positioning system receipts). The notification sent by the winning seller and the corresponding verification performed by the brokering system 106 is dependent on the task 310 being performed, the buyer 102 (e.g., application program), and/or other criteria.

After verification, the brokering system 106 arranges the transfer of compensation from the buyer 102 to the winning seller. For example, the brokering system 106 may transfer a payment amount from the buyer 102 to the winning seller, pay the winning seller and then charge or debit the buyer 102, connect the buyer 102 with the winning seller to complete payment independent from the brokering system 106, or otherwise facilitate payment to the winning seller. In some embodiments, the brokering system 106 maintains an account associated with the winning seller and credits the account with the payment amount. In other embodiments, the payment is non-monetary (e.g., a good, service, or other non-monetary compensation). In an example in which the buyer 102 sends the winning seller a camera to use broadcast video to the buyer 102, the winning seller gets to keep the camera as the compensation. In another example, the winning seller receives a coupon or discount from the buyer 102 as compensation if the winning seller agrees to location-targeted advertising. In still another example, the compensation includes a trade or exchange, such as the buyer 102 trading the winning seller a week at an apartment in New York for a week at an apartment in London.

In an example based on FIG. 2, the buyer 102 is an application program offering streaming video data from around the world. The application program interacts with the brokering system 106 to offer the streaming video data. In this example, the interaction of the application program with the brokering system 106 is hidden from the users 202. Aspects of the disclosure contemplate other application programs in which the interaction with the brokering system 106 is hidden from the users 202.

In the streaming video data example, one of the users 202 interacts with the application program to select a geographic region on a map displayed in a user interface. Alternatively, the user 202 identifies a landmark, city, state, zip code, address, or other criteria for selecting the geographic region. The buyer 102 (e.g., application program) receives the selection of the geographic region via the user interface. The buyer 102 forms a task request including one or more of the following: the selected geographic area in which to obtain the video data, an identity associated with the requesting user 202, a maximum price for obtaining the video data of the selected geographic region, a time value representing a time to capture the video data, and a duration for capturing the video data. For example, the task request is a tuple of the following form: <user, task location, task description, task time, maximum price>. The buyer 102 may also specify a quantity of the sellers 104 desired to complete the task 310. The buyer 102 submits the task 310 to the brokering system 106.

The brokering system 106 identifies one or more of the sellers 104 located in the selected geographic region. For example, the brokering system 106 may maintain a current location of each of the sellers 104 (e.g., by receiving location updates from the sellers 104). The brokering system 106 may also maintain a past history of the locations of the sellers 104 to enable an application program to, for example, find the sellers 104 that visited a particular location at a particular time or time period. In some embodiments, the sellers 104 subscribe to provide video data from their particular location, and the brokering system 106 maintains a list of the subscribed sellers 104 per location (e.g., per metropolitan area or landmark).

The brokering system 106 provides at least a portion of the task 310 to the identified sellers 104. Using any means for selecting one of the sellers 104, the brokering system 106 selects the winning seller from the identified sellers 104. The winning seller accepts the task 310 and begins streaming the video data to the user 202 at the requested time. The streaming video data represents the output of performance of the task 310. The winning seller notifies the brokering system 106 of task acceptance, start of streaming, or other indication of performance of the task 310. The brokering system 106 verifies the streaming by, for example, sampling some of the streaming or receiving a positive indication from the user 202 (e.g., the user 202 acknowledges receipt of the video data). The brokering system 106 may also verify task performance by confirming that the winning seller is located at the location specified in the task request. For example, the brokering system 106 may request position receipts from the winning seller or otherwise confirm the location of the winning seller. The position receipts represent proof of location from a location determination system or location-providing system such as a global positioning system (GPS). The position receipts include a timestamp proving that the winning seller is at the location at the desired time.

Alternatively or in addition, the video data is routed through the brokering system 106 to the user 202. In such embodiments, the streaming video data acts as a notification from the winning seller of performance of the task 310. The brokering system 106 verifies the streaming by examining the received video data or by examining location receipts (e.g., as proof of being at the location).

After verification of task performance, the brokering system 106 arranges compensation for the streaming video data by, for example, making a payment to the winning seller, crediting a financial account associated with the winning seller, making a non-monetary payment to the winning seller, or connecting the user 202 with the winning seller to complete payment.

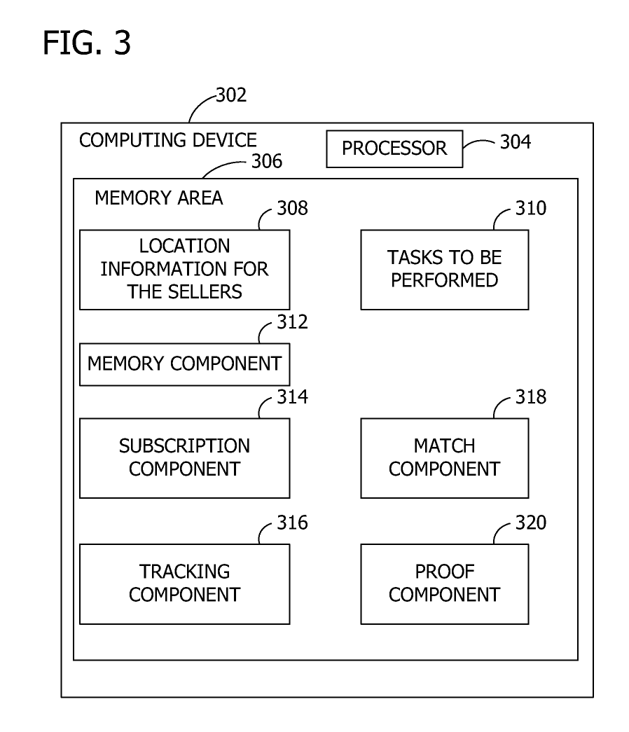

Referring next to FIG. 3, an exemplary block diagram illustrates a computing device 302 having a memory area 306 storing components for implementing the location-based brokering system 106. In some embodiments, the computing device 302 represents a plurality of computing devices programmed to implement the functionality described herein.

The computing device 302 includes at least a memory area 306 and a processor 304. The memory area 306, or other computer-readable media, stores location information 308 associated with the sellers 104. The location information 308 identifies the locations of the sellers 104. In some embodiments, the location information 308 includes time values corresponding to the locations. For example, the location information 308 identifies current locations, past locations, and/or future locations. The memory area 306 further stores a list of other identification of one or more of the tasks 310 to be performed.

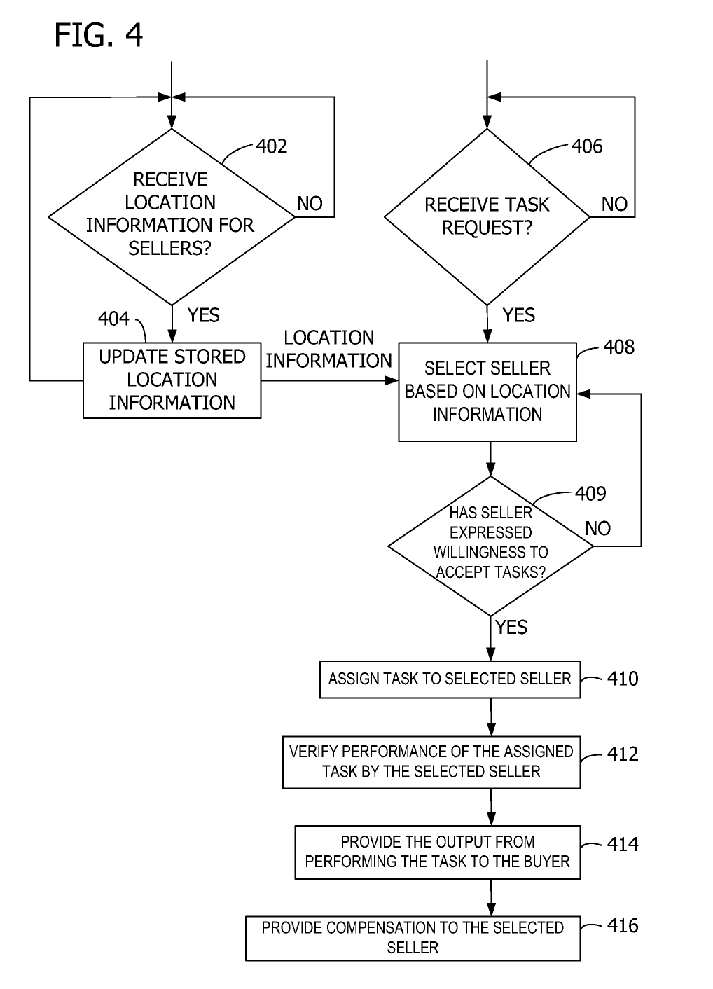

The memory area 306, or one or more computer-readable media, further stores computer-executable components for implementing aspects of the disclosure. For example, the components and other data may be stored in a database. Exemplary components include a memory component 312, a subscription component 314, a tracking component 316, a match component 318, and a proof component 320. These components are described below with reference to FIG. 4.

In general, the memory area 306 is associated with the computing device 302. For example, in FIG. 3, the memory area 306 is within the computing device 302. However, the memory area 306 includes any memory area internal to, external to, or accessible by computing device 302. Further, the memory area 306 or any of the data stored thereon may be associated with any server or other computer, local or remote from the computing device 302 (e.g., accessible via a network).

The processor 304 includes any quantity of processing units, and is programmed to execute computer-executable instructions for implementing aspects of the disclosure. The instructions may be performed by the processor 304 or by multiple processors executing within the computing device 302, or performed by a processor external to the computing device 302 (e.g., by a cloud service). In some embodiments, the processor 304 is programmed to execute instructions such as those illustrated in the figures (e.g., FIG. 4).

Referring next to FIG. 4, an exemplary flow chart illustrates selection of the sellers 104 and payment to the selected sellers 104 for performing tasks 310. As the location information 308 is received from one or more of the sellers 104 at 402, the location information 308 is maintained or otherwise stored at 404. In some embodiments, the location information 308 is received and stored by the brokering system 106. In other embodiments, another system receives and stores the location information 308, and makes the stored location information 308 available to the brokering system 106.

The brokering system 106 checks for receipt of a task request at 406. The task request is received from at least one of the buyers 102. The task request includes, among other data, a description of the task 310 to be performed, a task location associated with the task 310, a task time at which to perform the task 310, and compensation (e.g., a monetary payment amount or non-monetary compensation) associated with performance of the task 310. In some embodiments, the brokering system 106 compares or matches the location from the task request with the location information 308 for the sellers 104. The brokering system 106 selects at least one of the sellers 104 at 408 based on the comparison.

In other embodiments, the brokering system 106 selects the seller 104 at 408 using an auction. In such embodiments, the brokering system 106 sends at least a portion of the task request to a plurality of the sellers 104 as a notification. For example, the notification identifies the task 310, the task location, and the task time. The brokering system 106 receives one or more bids for performing the task 310 from the plurality of sellers 104 during a predefined time limit. The brokering system 106 selects the seller 104 based on the received bids. For example, the brokering system 106 may select the seller 104 submitting the lowest bid, or select the first seller 104 to submit a bid.

In still other embodiments, the brokering system 106 selects the seller 104 at 408 based at least in part on a feedback score, confidence factor, or other reliability or capability metric associated with the sellers 104. For example, the brokering system 106 may select the seller 104 with the greatest feedback score, or allow sellers 104 with a pre-defined threshold feedback score to bid on a task request. The feedback score represents a measure of confidence that the brokering system 106 has in the seller 104. The feedback score may be compiled based on feedback from previous buyers 102, sellers 104, or other entities. The brokering system 106 calculates or determines the feedback score for each of the sellers 104 after each transaction involving the sellers 104.

In some embodiments, the brokering system 106 broadcasts the task request to the sellers 104 who are in or near the task location and meet any criteria specified by the buyer 102 in the task request. The brokering system 106 may also receive notification of a willingness or acceptance by one or more of the sellers 104 to perform the task 310 in the task request. The brokering system 106 selects one of the willing sellers 104. If the brokering system 106 confirms at 409 that the selected seller 104 has expressed a willingness to perform the task 310, the brokering system 106 assigns the task request to the selected seller 104 at 410. The selected seller 104 performs the task 310 at the task location and task time identified in the task request. In some embodiments, the seller 104 produces output as a result of performing the task 310. For example, the produced output may include digital merchandise.

The brokering system 106 verifies performance of the assigned task 310 by the selected seller 104 at 412. In some embodiments, the brokering system 106 receives proof of performance of the task 310 from the selected seller 104. The proof of performance includes any data verifying that the task 310 was performed at the task location and at the task time. For example, the proof of performance includes one or more of the following: time stamped position receipts from the selected seller 104 (e.g., GPS receipts), a copy of the output produced by the seller 104 when performing the task 310, and a shipping receipt from shipping a physical good (e.g., part of the produced output) to the buyer 102. The brokering system 106 may verify performance of the task 310 by comparing the time stamped position receipts with the data from the task request, examining the produced output, or confirming the authenticity of the shipping receipt.

After verifying performance of the task 310 at 412, the output from performing the task 310 is provided to the buyer 102 at 414. For example, the output may be provided from the seller 104 to the buyer 102 without passing through the brokering system 106, or the output may be provided from the seller 104 through the brokering system 106 to the buyer 102 (e.g., the output is posted to a web site or other accessible area associated with the brokering system 106).

Further in response to verifying performance of the task 310 at 412, the compensation is provided to the seller 104 at 416. In some embodiments, the compensation includes a payment amount corresponding to a maximum amount the buyer 102 is willing to pay. In other embodiments, the payment amount is less than the maximum amount.

In some embodiments, one or more computer-executable components, such as the components illustrated in FIG. 3, execute on the computing device 302 perform the operations illustrated in FIG. 4. The memory component 312, when executed by the processor 304, causes the processor 304 to store the tasks 310 to be performed by the sellers 104. The tasks 310 are received from the buyers 102. The subscription component 314, when executed by the processor 304, causes the processor 304 to publish at least one of the tasks 310 and receive subscriptions to the published tasks 310 from one or more of the sellers 104. The subscriptions represent an open-ended willingness to perform particular tasks 310 or categories of tasks 310. The tracking component 316, when executed by the processor 304, causes the processor 304 to maintain the location information 308 for the sellers 104. For example, the tracking component 316 updates the location information 308 as the sellers 104 move geographically (e.g., across a geographic region). The match component 318, when executed by the processor 304, causes the processor 304 to assign the tasks 310 to the sellers 104 based on the location information 308 maintained by the tracking component 316 and the subscriptions received by the subscription component 314. For example, the match component 318 may implement an auction to assign the tasks 310. The proof component 320, when executed by at least one processor 304, causes the processor 304 to verify performance of the tasks 310 by the sellers 104. For example, the proof component 320 verifies performance of the tasks 310 by verifying proof of delivery of physical or digital merchandise.

### EXAMPLES

Various implementations of the brokering system 106 are contemplated. For example, the location information 308 maintained by the brokering system 106 includes not only the location of the sellers 104, but other information as well. In some embodiments, one of the tasks 310 to be performed includes obtaining a merchandise item associated with a requested time and a requested location. For example, the merchandise item is a t-shirt, and the requested time and the requested location correspond to an upcoming concert. In such an embodiment, the brokering system 106 identifies the sellers 104 that have offered to provide merchandise, or might be willing to provide such merchandise, based on the location information 308 from the sellers 104.

In a further example, the location information 308 provided by the sellers 104 may also include a description of merchandise the sellers 104 have acquired at a particular time and location. The brokering system 106 thus maintains a virtual inventory of time stamped goods. One of the tasks 310 from the buyers 102 may include a request to obtain a particular merchandise item associated with a requested time and a requested location. For example, after a concert, one of the buyers 102 wants to obtain a t-shirt from someone who actually attended the concert and bought a t-shirt. In this example, the brokering system 106 identifies the appropriate sellers 104 based on the stored location information 308 (e.g., by searching the location information 308 based on the merchandise item, request time, and request location).

In other embodiments, the brokering system 106 provides one or more targeted advertisements to the buyer 102 after selecting the seller 104 to perform the task 310 from the buyer 102. The advertisements are selected based on one or more of the following: the seller 104 performing the task 310, the task description, the task location, the task time, the compensation associated with performance of the task 310, and the buyer 102 requesting the task 310. The targeted advertisements are provided to the buyer 102 during or after performance of the task 310. For example, if the task 310 results in a digital deliverable such as streaming video data, the targeted advertisements may be inserted into the streamed video data for display before, after, or simultaneously with the video data. In another example, if the task 310 results in a physical deliverable (e.g., a shipped merchandise item), the targeted advertisements may be included with the physical deliverable (e.g., in a box containing the merchandise item).

The brokering system 106 may receive a plurality of similar task requests from the buyers 102. For example, the brokering system 106 may receive a plurality of requests from the buyers 102 for a rare merchandise item. Because of the limited pool of sellers 104 offering the rare merchandise item, the brokering system 106 may implement an auction or other bidding process to select the buyer 102 to receive the rare merchandise item. In such embodiments, the task request from the buyers 102 includes the payment amount representing the maximum amount (e.g., a bid) each buyer 102 is willing to pay for the rare merchandise item. The brokering system 106 selects the buyer 102 based on, for example, the highest bid received within a time limit. The selected buyer 102 is able to complete the transaction with the seller 104 to obtain the merchandise item.

In another example, an application program uses the brokering system 106 to connect rideshare partners based on location. In this example, the buyer 102 forms a task request including a task to find a rideshare partner at a particular start location at a particular time with a particular destination location. The brokering system 106 identifies one or more of the sellers 104 based on the data from the task request. For example, the brokering system 106 uses a location history of the sellers 104 to identify a set of the sellers 104 who will likely be traveling from the particular start location to the particular destination location at the particular time. The brokering system 106 enables the buyer 102 to select one of the identified sellers 104. The selected seller 104 notifies the brokering system 106 of task acceptance or initiation by providing pickup details to the buyer 102 through the brokering system 106. The brokering system 106 verifies task completion by receiving position receipts from the selected seller 104 indicating that the selected seller 104 is at the particular location at the particular time. Responsive to verifying task completion, the brokering system 106 arranges for the transfer of compensation between the buyer 102 and the seller 104. In other embodiments, the brokering system 106 is notified or task acceptance or completion in different ways, and verifies task performance in different ways, within the scope of the disclosure.

Other examples of the brokering system 106 enable a company (e.g., buyer 102) to pay someone (e.g., seller 104) to wear a logo t-shirt at an event for advertising purposes, a news company (e.g., buyer 102) to request video footage of an event from someone (e.g., seller 104) who was at the event, a person (e.g., buyer 102) in a first country to request someone (e.g., seller 104) in a second country to buy merchandise not available in the first country, or a person (e.g., buyer 102) to pay someone (e.g., a seller 104) to place a bet on a roulette table in a casino remote from the buyer 102.

### Exemplary Operating Environment

By way of example and not limitation, computer readable media comprise computer storage media and communication media. Computer storage media store information such as computer readable instructions, data structures, program modules or other data. Communication media typically embody computer readable instructions, data structures, program modules, or other data in a modulated data signal such as a carrier wave or other transport mechanism and include any information delivery media. Combinations of any of the above are also included within the scope of computer readable media.

Although described in connection with an exemplary computing system environment, embodiments of the invention are operational with numerous other general purpose or special purpose computing system environments or configurations. Examples of well known computing systems, environments, and/or configurations that may be suitable for use with aspects of the invention include, but are not limited to, mobile computing devices, personal computers, server computers, hand-held or laptop devices, multiprocessor systems, gaming consoles, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks 310 or implement particular abstract data types. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

Aspects of the invention transform a general-purpose computer into a special-purpose computing device when configured to execute the instructions described herein.

The embodiments illustrated and described herein as well as embodiments not specifically described herein but within the scope of aspects of the invention constitute exemplary means for defining the task requests, exemplary means for selecting the plurality of sellers 104, exemplary means for assigning the received task request to the selected sellers 104, exemplary means for receiving the proof of performance of the task 310 by the selected sellers 104, and exemplary means for providing the compensation to the selected sellers 104.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. A system for brokering locations for task performance, said system comprising:
a memory area for storing location information associated with a plurality of sellers; and
a processor programmed to:
receive a task request from one of a plurality of buyers, said received task request identifying a task defined by said one of the plurality of buyers, a task location, a task time, and compensation associated with performance of the task;
select at least one of the plurality of sellers based at least on the location information stored in the memory area;
assign the received task request to said at least one of the plurality of sellers, wherein said at least one of the plurality of sellers performs the task at the task location at the task time to produce output;
receive proof of performance of the task by said at least one of the plurality of sellers;
provide the produced output to said one of the plurality of buyers in response to receiving the proof of performance; and
provide the compensation to said at least one of the plurality of sellers in response to receiving the proof of performance.

2. The system of claim 1, wherein the location information identifies a location and corresponding time associated with the sellers.

3. The system of claim 1, wherein the compensation corresponds to a maximum amount said one of the plurality of buyers is willing to pay, and wherein the processor is programmed to select said at least one of the plurality of sellers by conducting an auction.

4. The system of claim 1, wherein the task request defines criteria, and wherein the processor is programmed to:
identify one or more of the plurality of sellers who meet the task criteria;
broadcast the received task request to the identified sellers;
receive notification of task acceptance from at least one of the identified sellers; and
assign the received task request to at least one of the identified sellers who have accepted the task.

5. The system of claim 1, wherein the processor is programmed to select said at least one of the plurality of sellers by matching the task location with the location information in the memory area.

6. The system of claim 1, wherein said one of the plurality of buyers is an application program that received the task from a user, and wherein the processor is programmed to select said at least one of the plurality of sellers by:
sending a notification to the plurality of sellers, said notification identifying at least the task, the task location, and the task time;
receiving one or more bids for performing the task from the plurality of sellers; and
selecting at least one of the received bids, wherein the processor is programmed to provide the produced output to the application program, and wherein the application program provides the produced output to the user.

7. The system of claim 1, further comprising means for defining the task requests.

8. The system of claim 1, further comprising:
means for selecting said at least one of the plurality of sellers;
means for assigning the received task request to said at least one of the plurality of sellers;
means for receiving said proof of performance of the task by said at least one of the plurality of sellers; and
means for providing the compensation to said at least one of the plurality of sellers.

9. A method comprising:
maintaining, by a processor, location information for a plurality of sellers, said location information identifying locations corresponding to the plurality of sellers;
storing, by the processor in a memory area, tasks to be performed by the plurality of sellers, said tasks being defined by and received from one or more buyers;
assigning, by the processor, the stored tasks to one or more of the plurality of sellers based at least on the location information, wherein said one or more of the plurality of sellers perform the assigned tasks to produce output;
verifying performance of the assigned tasks by said one or more of the plurality of sellers at the locations corresponding thereto; and
providing, responsive to said verifying the performance, the produced output to the one or more buyers.

10. The method of claim 9, further comprising determining a feedback score for each of the plurality of sellers, and wherein assigning the stored tasks comprises assigning the stored tasks based on the determined feedback score.

11. The method of claim 9, wherein storing the tasks comprises storing one or more of the following: a task description, a task location, a task time, and compensation associated with performance of the task.

12. The method of claim 11, wherein one or more of the tasks corresponds to obtaining merchandise items, and further comprising:
associating the task location and the task time of said one or more of the tasks with the corresponding merchandise items;
receiving a request to search the merchandise items, said received request including one or more of the following: a request location and a request time; and
searching the merchandise items responsive to the received request.

13. The method of claim 11, further comprising:
selecting advertisements for the assigned tasks based on one or more of the following: said one or more of the plurality of sellers, the task description, the task location, the task time, the compensation associated with performance of the task, and said one or more buyers; and
providing the selected advertisements to said one or more buyers.

14. The method of claim 9, wherein the maintained location information for the plurality of sellers includes current locations for the plurality of sellers, and further comprising generating a map identifying the current locations of the plurality of sellers.

15. The method of claim 9, wherein the one or more buyers include application programs, wherein the stored tasks include capturing video data, and wherein providing the produced output includes providing the captured video data.

16. One or more computer-readable media having computer-executable components, said components comprising:
a memory component that when executed by at least one processor causes the at least one processor to store tasks to be performed by a plurality of sellers, said tasks being defined by and received from one or more buyers;
a subscription component that when executed by at least one processor causes the at least one processor to publish at least one of the tasks and receive subscriptions from one or more of the plurality of sellers to the published tasks;
a tracking component that when executed by at least one processor causes the at least one processor to maintain location information for at least the plurality of sellers;
a match component that when executed by at least one processor causes the at least one processor to assign the tasks to the plurality of sellers based on the location information maintained by the tracking component and the subscriptions received by the subscription component; and
a proof component that when executed by at least one processor causes the at least one processor to verify performance of the tasks by the plurality of sellers.

17. The computer-readable media of claim 16, wherein the proof component verifies performance of the tasks by receiving position receipts from the plurality of sellers, and wherein the position receipts comprise position receipts from a location-providing system.

18. The computer-readable media of claim 16, wherein the proof component verifies performance of the tasks by verifying proof of delivery of physical or digital merchandise.

19. The computer-readable media of claim 16, wherein the tracking component updates the location information as the plurality of sellers move geographically.

20. The computer-readable media of claim 16, wherein the match component implements an auction to assign the tasks to the plurality of sellers.
